(19) United States
(12) Patent Application Publication
(10) Pub. No.: US 2004/0143502 A1
(43) Pub. Date: Jul. 22, 2004

(54) Guaranteed pricing systems

(76) Inventor: Guy L. McClung III, Spring, TX (US)

Correspondence Address: Guy McClung, No. 347, 16690 Champion Forest Drive, Spring, TX, 77379-7023, US

(21) Appl. No.: 10/752,066

(22) Filed: Jan. 6, 2004

Related U.S. Application Data
(63) Continuation-in-part of application No. 09/506,718, filed on Feb. 18, 2000, now abandoned.
(63) Continuation-in-part of application No. 09/375,451, filed on Aug. 17, 1999.
(63) Continuation-in-part of application No. 09/637,293, filed on Aug. 11, 2000.

(51) Int. Cl. G06F 17/60

(52) U.S. Cl. 705/14

(57) ABSTRACT

A computer implemented method for guaranteeing a consumer a best price on an item or service purchased from a vendor in a first transaction at a first time at a first price, the method in certain aspects including storing in a first database data for the first price and information identifying the consumer, inputting at least one later-in-time second price for the item or service, determining, during a predetermined time period, any lower second price for the item, comparing the two prices and calculating a money-value difference therebetween, and refunding to the consumer a refund amount equal to the money-value difference; and, in one aspect, entering the consumer in a contest upon completion of the first transaction.

### RELATED APPLICATION

This is a continuation-in-part of U.S. application Ser. No. 09/506,718 filed Feb. 18, 2000; Ser. No. 09/375,451 filed Aug. 17, 1999; and 09/637,293 filed Aug. 11, 2000—all incorporated fully herein for all purposes.

### BACKGROUND OF THE INVENTION

1. Field of the Invention

This invention relates to improvements to business systems with which a customer can be in direct electronic communication with a vendor, e.g., via a system such as the Internet global communications system. In certain aspects, this invention relates to such systems that also provide guaranteed pricing for a predetermined time period so that a consumer is assured that an item purchased will not be sold in the near future at a discount or sale price which is not made available to the consumer.

2. Description of Related Art

The U.S. application Ser. No. 09/375,934 entitled “Business System” naming Sunil Thakur and Zulfiqar Momin as inventors filed on Aug. 17, 1999 is incorporated fully herein for all purposes including its discussion of Related Art.

There has long been a need, recognized by the present inventor, for a system that provides to a consumer the assurance that the consumer will not buy an item or service and then find out in the near future that the item or service was made available at a much lower price. There has long been a need for such a system usable with Internet business systems and network systems.

### SUMMARY OF THE PRESENT INVENTION

The present invention, in certain aspects, provides a system that, in certain aspects, includes any of the systems and/or methods disclosed in the previously-mentioned “Business System” patent application—Ser. No. 09/375,934—additionally with the following: a method in which a vendor who sells a business or service to a consumer maintains a record of the sale and monitors that item (or service) for a preset time period (e.g., but not limited to, for a week, a month, three months, six months, or a year). If the item is offered at a lower price then the consumer paid, or for sale within the preset time period with any additional new incentive and/or at a lower cost than that paid by the consumer, the consumer is automatically given a refund, a credit, and/or a coupon or certificate good for use equal to the difference in sales prices and/or including value for the new incentive. Alternatively, the vendor may make available a refund, etc. of lesser or of more value than the price difference. Alternatively, a host system or any centralized system as disclosed in the “Business System” patent application (or in any prior art system cited therein) may record the sale, monitor the vendor and the product (or service) for the preset time period, and handle the making available of the refund, etc. to the consumer. The subsequent price or prices to be compared to an initial first sales price can be limited to subsequent retain prices or it may include subsequent on-sale and/or discounted prices.

In other embodiments, the vendor (and/or host system or other system) monitors all vendors of such an item; monitors all vendors of such an item in a pertinent geographic area as defined in the “Business System” patent application; and/or monitors all providers of the item as identified by the manufacturer thereof. In certain aspects, the consumer is alerted to the fact that a refund is available or that a refund has been made by phone, by fax; and/or by email. In one embodiment, a consumer using a host system or similar system is automatically notified of such a refund, etc. upon logging on to the host system, e.g., but not limited to by a blinking icon or message such as “You've Got Refund$.” In one aspect, when a consumer has an account with the vendor (or an account with the host system or similar system), the account is automatically credited with the refund amount. Such a blinking icon and/or message may also be used with the methods of the “Business System” patent application to alert a consumer to: a retirement account contribution (e.g. but not limited to “You've Got IRA$”; “You've Got Retirement $”; or simply “Retirement $”); an available coupon (e.g. but not limited to “You've Got Coupons”; “You've God Coupon $”; or simply “Coupons” or “Coupon $”); future rewards or future “bucks” (e.g. but not limited to “You've God Future rewards;” “You've Got Futurereward$”; “You've Got Futurebucks;” “You've Got Futurebuck$”; “Futurerewards”; “Futurereward$”; “Futurebucks”; “Futurebuck$”; “You've Got Discounts”; “You've Got Discount$”; “Discounts” or “Discount$”.

In certain embodiments a price guaranteeing system according to the present invention can also monitor the vendor's competitors and guarantee to a consumer that if any competitor offers a lower price (and/or new incentive), the consumer will get the benefit of the competitor's lower price. In one aspect, the vendor (and/or host system or similar system) monitors competitors on a real time basis and provides the consumer at the vendor's location any better price available then at any competitor for the same item (or service). In one aspect such a method includes making available presenting to the consumer any coupon, rebate, incentive etc. offered by a competitor. Such “incentive matching” can be limited, in certain embodiments, to a pertinent geographic area.

Any method and system according to the present invention may also be in communication with and part of any airline's frequent flyer mile program so that sales and refunds, etc. qualify for miles. To alert a consumer that miles have been earned related to a transaction, a blinking icon or message as described above may be used, e.g., but not limited to “Miles”; “You've Got Miles”; and “Mile$”.

In one aspect a host system or similar system (e.g. but not limited to as in the “Business System” patent application and any prior art system disclosed therein) maintains a listing of vendor's that subscribe to and use the host system (or other system). When a consumer is afforded a refund, etc. based on a competitor's offerings, the host system can contact the competitor informing it that the competitor's offering was used as a refund basis and making available to the competitor a subscription for the host system.

In another aspect, whenever a consumer uses the host system or other system for any inquiry and/or transaction, the host system can contact any non-subscribing vendor that offers such a product or service and alert them to the fact that a sale was missed, then offer the non-subscribing vendor a subscription or sign-up agreement.

In other embodiments any system and method described herein may include the following (or any Internet system may use the following): when a consumer makes a purchase via the system, warranty information and/or warranty sign-up processing may be made available to the consumer by phone, by fax, by email, and/or via an interactive Internet site. A blinking icon or message as discussed above may be used to alert a consumer regarding warranties, e.g., but not limited to “Warranty !”; Warranties”; “Warranty$”; “You've Got Warranty”; or “You've Got Warranty$”. The consumer can, via an interactive Internet site (e.g. of the host system, the vendor, other systems, and/or the manufacturer) provide the sales and product information to activate the warranty. Similarly, by phone, fax, email, and/or interactive Internet site, a consumer can be alerted to possible warranty extensions and/or renewals and can apply for them.

What follows are some of, but not all, the objects of this invention. In addition to the specific objects stated below for at least certain preferred embodiments of the invention, other objects and purposes will be readily apparent to one of skill in this art who has the benefit of this invention's teachings and disclosures. It is, therefore, an object of at least certain preferred embodiments of the present invention to provide:

New, useful, unique, efficient, nonobvious systems and methods for providing direct electronic consumer/vendor contact for business transactions via a system such as the Internet global communications system;

New, useful, unique, efficient, nonobvious systems and methods for providing to a consumer guaranteed best pricing for a present sale and/or for a preset future time period;

Such business methods and/or coupon methods which include defining a particular geographic area of interest to a consumer;

Such methods which make refunds, etc., available to consumers even if they are unaware of them;

Such methods which a consumer can avail him or herself of via a host system and/or via an Internet network; and

Such methods and systems which automatically apply a refund and/or an incentive, past or future, to a system user's account.

Certain embodiments of this invention are not limited to any particular individual feature disclosed here, but include combinations of them distinguished from the prior art in their structures and functions. Features of the invention have been broadly described so that the detailed descriptions that follow may be better understood, and in order that the contributions of this invention to the arts may be better appreciated. There are, of course, additional aspects of the invention described below and which may be included in the subject matter of the claims to this invention. Those skilled in the art who have the benefit of this invention, its teachings, and suggestions will appreciate that the conceptions of this disclosure may be used as a creative basis for designing other structures, methods and systems for carrying out and practicing the present invention. The claims of this invention are to be read to include any legally equivalent devices or methods which do not depart from the spirit and scope of the present invention.

The present invention recognizes and addresses the previously-mentioned problems and long-felt needs and provides a solution to those problems and a satisfactory meeting of those needs in its various possible embodiments and equivalents thereof. To one skilled in this art who has the benefits of this invention's realizations, teachings, disclosures, and suggestions, other purposes and advantages will be appreciated from the following description of preferred embodiments, given for the purpose of disclosure, when taken in conjunction with the accompanying drawings. The detail in these descriptions is not intended to thwart this patent's object to claim this invention no matter how others may later disguise it by variations in form or additions of further improvements.

### DESCRIPTION OF THE DRAWINGS

A more particular description of embodiments of the invention briefly summarized above may be had by references to the embodiments which are shown in the drawings which form a part of this specification. These drawings illustrate certain preferred embodiments and are not to be used to improperly limit the scope of the invention which may have other equally effective or legally equivalent embodiments.

FIG. 1 is a diagrammatic illustration of a traditional prior art paper-based bill presentment and payment system.

FIG. 2 is a diagrammatic illustration of a prior art electronic bill payment systems operated by companies like CheckFree Corporation.

FIG. 3 is a diagrammatic illustration of a prior art electronic bill payment system proposed by Visa International.

FIG. 4 is a diagrammatic illustration of a bill presentment and payment system according to one implementation of this invention.

FIG. 5 is a flow diagram of a method for electronically presenting and paying bills using the FIG. 4 system.

FIG. 6 is a diagrammatic illustration of a bill presentment and payment system according to still another implementation of this invention.

FIG. 7 is a diagrammatic illustration of a bill presentment and payment system according to still another implementation of this invention.

FIGS. 8, 10 and 11 are schematic views of systems and/or methods according to the present invention.

FIG. 9 is a schematic view of a personal computer useful with a system according to the present invention.

### DESCRIPTION OF EMBODIMENTS PREFERRED AT THE TIME OF FILING FOR THIS PATENT

The present invention, in certain preferred embodiments, provides a method for guaranteeing a consumer a best price on an item (or for a service) purchased from a vendor (either over a computer network or host system or at a vendor location) in a first transaction at a first price, the method including recording the first price (on paper, in an electronic chip, in a computer device, in a computer system or in computer memory) and information identifying the consumer, monitoring the sales price of the item for a predetermined time period after the first transaction, noting (either manually or electronically e.g. with a computer device) any price lower than the first price for the item during the predetermined time period, calculating (either manually, by calculator, electronically and/or by computer) a money-value difference between the first price and said any price lower than the first price, and refunding (in cash in hand paid; by crediting a consumer's account; by providing coupons or certificates; and/or by making the amount available to the consumer either on-line in a computer network or at a vendor location) to the consumer an amount equal to the money-value difference. The method can be done manually with paper records; on a suitably programmed computer and/or computer system or network; and/or via a host system or any other system, e.g. but not limited to as described in the “Business System” patent application or in any prior art system discussed therein.

In certain aspects, the guaranteed pricing is in effect for only one or two price changes. In other aspects, the guaranteed pricing is in effect throughout an entire preset time period and all lower prices will automatically be applied. The “any price lower than the first price” can be limited to any lower price offered by the particular vendor involved in the first transaction and/or can be limited to a lower price that becomes available in a pertinent geographic area. Alternatively, the “any lower price” can be based on a preset group of vendors including competitors of the vendor involved in the first transaction, all suppliers of the item (or service), e.g. but not limited to city-wide, state-wide, country-wide, or world-wide; and/or competitors who have signed up to be included in the base of price sources.

In certain aspects, methods as described above can include alerting a consumer regarding a refund based on a new lower price. Consumers can be alerted, e.g. by phone, fax, email, and/or via an interactive Internet site, e.g. but not limited to with a host system or other system (e.g. or in the “Business System” patent application and in any prior art system disclosed therein). Methods according to the present invention can also take into account new incentives to buy the item that was the subject of the first transaction (e.g. frequent flyer miles, discounts on other items or services, rebates, coupons for the same or other items or services in the future, cheaper or free warranties or extended warranties, etc.). A money-value is assigned to the new incentive and this is made available to the consumer and/or, if possible, the actual new incentive itself. The refunds, etc. and/or new incentives can be made available and/or paid for by a vendor, a host system or other similar system, a manufacturer, and/or a third party administrator of a host system.

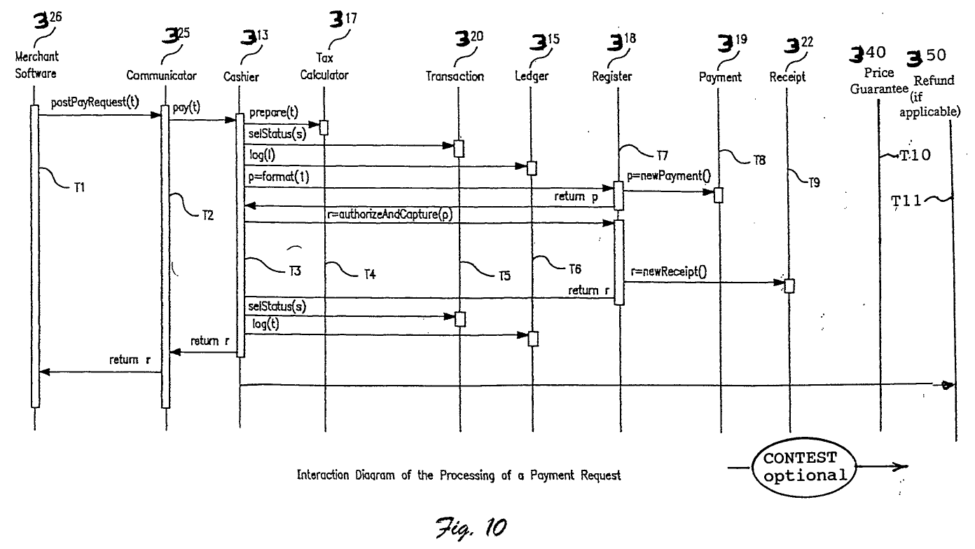

The present invention, therefore, discloses in some, but not necessarily all embodiments, a business system for guaranteeing a consumer a best price on an item purchased from a vendor in a first transaction at a first price, the system as shown in FIG. 8 including means for recording the first price and information identifying the consumer, means for monitoring the sales price of the item for a predetermined time period after the first transaction, means for noting any price lower than the first price for the item during the predetermined time period, means for calculating a money-value difference between the first price and said any price lower than the first price, and means for refunding to the consumer an amount equal to the money-value difference; and, optionally, a host system that includes the means for recording, means for monitoring, means for noting, and means for calculating; means for duplicating for the consumer any incentive accompanying sales of the item after the first transaction during the predetermined time period; means for determining a pertinent geographic area for the first transaction and for limiting the monitoring step to sales prices available within the pertinent geographic area; and/or means for providing a warranty to the consumer.

The present invention, therefore, discloses in some, but not necessarily all embodiments, a business system with a magnetic strip card with consumer identifying information encoded thereon said information identifying a consumer desiring to conduct a transaction with a vendor, a host system that maintains information about discounts from said vendor, an apparatus for reading information on the magnetic strip card, said apparatus interconnected with and in communication with the host system, and means for applying any applicable discount related to said transaction for the benefit of said consumer, improvements as shown in FIG. 9 including means for guaranteeing a consumer a best price on an item purchased from the vendor in a first transaction at a first price, said means further including means for recording the first price and information identifying the consumer, means for monitoring the sales price of the item for a predetermined time period after the first transaction, means for noting any price lower than the first price for the item during the predetermined time period, means for calculating a money-value difference between the first price and said any price lower than the first price, and means for refunding to the consumer an amount equal to the money-value difference.

The present invention therefore, in certain embodiments, provides improvements for a method for generating vendor information including contacting a host system by a consumer, identifying a pertinent geographic area of interest to the consumer, identifying at least one vendor doing business in the pertinent geographic area, retrieving from the host system information related to the at least one vendor, and displaying said information for the consumer; and in one aspect such a method includes automatically displaying and/or downloading to a computer the information to the consumer—the improvements including providing a method to guarantee to the consumer a better price or a best price on items or services purchased from the vendor for a predetermined time period following a transaction.

The present invention therefore, in certain embodiments, provides improvements for a method for a vendor to provide a future discount to a customer of the vendor, the method including noting a transaction amount indicative of value of a transaction between the customer and the vendor, based on the transaction amount, calculating a discount amount to be applied to a future transaction between the customer and the vendor, storing the discount amount for future use, and informing the customer of the discount amount; and such a method including applying the discount amount to a future transaction of the customer—the improvements including providing a method to guarantee to the consumer a better price or a best price on items or services purchased from the vendor for a predetermined time period following a transaction.

The present invention therefore, in certain embodiments, provides improvements for a method for making a contribution to a retirement account of a customer of a vendor, the method including noting a transaction amount indicative of value of a transaction between the customer and the vendor, based on the transaction amount, calculating a contribution amount to be made to a retirement account of the customer, and making a contribution to the customer's retirement account in the amount of the contribution amount; and such a method wherein the vendor, the customer, a third party administrator and/or a host system make the contribution to the retirement account—the improvements including providing a method to guarantee to the consumer a better price or a best price on items or services purchased from the vendor for a predetermined time period following a transaction.

The present invention therefore, in certain embodiments, provides improvements for a method for generating a coupon including contacting a host system by a consumer, identifying a pertinent geographic area of interest to the consumer, identifying at least one vendor doing business in the pertinent geographic area, retrieving from the host system information related to the at least one vendor and at least one coupon currently provided by the at least one vendor, and generating a coupon corresponding to the at least one coupon—the improvements including providing a method to guarantee to the consumer a better price or a best price on items or services purchased from the vendor for a predetermined time period following a transaction.

The present invention discloses, in at least some if not all embodiments, improvements for a business system with a magnetic strip card with consumer identifying information encoded thereon said information identifying a consumer desiring to conduct a transaction with a vendor, a host system that maintains information about discounts from said vendor, an apparatus for reading information on the magnetic strip card, said apparatus interconnected with and in communication with the host system, and means for applying any applicable discount (coupon, rebate, sales price, volume discount, reward, etc.) related to said transaction for the benefit of said consumer—the improvements including providing a method to guarantee to the consumer a better price or a best price on items or services purchased from the vendor for a predetermined time period following a transaction. Such a system may have one, some, or all of the following in any combination: wherein the apparatus for reading the information is located at a location of the vendor; wherein the apparatus for reading the information is located at a location of the consumer; a computer at the location of the consumer for the consumer to communicate with the host system; means for automatically downloading information to the computer without a request from the consumer; means at the host system for receiving from the vendor transaction information about said transaction, and means at the host system for storing said transaction information; means for calculating a future discount for the consumer based on the transaction information; means for providing the consumer with information about the future discount; means for calculating an amount of a retirement account contribution for a consumer based on the transaction information; means for making a contribution to a retirement account of the consumer based on the calculated amount (e.g. but not limited to a contribution made by a third party administrator, by the vendor, by the host system, or by the consumer); means for providing the consumer with a physical coupon for use in a transaction with the vendor; means for determining a pertinent geographic area for the consumer (e.g. but not limited to, based on phone number, zip code, and/or information inputted by a consumer); means for displaying for the consumer information about the vendor for the determined pertinent geographic area (which may be reduced or enlarged in scope by the consumer); means for displaying for the consumer information about a desired product or service available in the pertinent geographic area; means for automatically determining the pertinent geographic area based on information about a consumer, e.g. but not limited to a phone number used by the consumer to contact the host system; wherein the information about the consumer includes a phone number used by the consumer to contact the host system and/or a zip code of the consumer' location; wherein the consumer uses the Internet global communications system or some other similar communications network to contact the host system; and/or means for automatically downloading to the computer information about a vendor without a request from the consumer.

It is within the scope of certain preferred embodiments of the present invention to provide a method (and a corresponding system and/or apparatus) which is an improved version of the subject matter of these U.S. Pat. Nos.: U.S. Pat. No. 6,018,717, Jan. 25, 2000; U.S. Pat. No. 6,014,634, Jan. 11, 2000; U.S. Pat. No. 6,014,635, Jan. 11, 2000; U.S. Pat. No. 6,014,636, Dec. 21, 1999; U.S. Pat. No. 6,006,205, Dec. 21, 1999; U.S. Pat. No. 6,009,408, Dec. 28, 1999; U.S. Pat. No. 6,009,411, Dec. 28, 1999; U.S. Pat. No. 6,009,413, Dec. 28, 1999; U.S. Pat. No. 5,995,942, Nov. 30, 1999; U.S. Pat. No. 5,999,919, Dec. 7, 1999; U.S. Pat. No. 5,999,914, Dec. 7, 1999; U.S. Pat. No. 5,991,739, Nov. 23, 1999; U.S. Pat. No. 5,895,454, Apr. 20, 1999; U.S. Pat. No. 5,960,411, Sep. 28, 1999; U.S. Pat. No. 5,991,738, Nov. 23, 1999; U.S. Pat. No. 5,857,175, Jan. 5, 1999; U.S. Pat. No. 5,794,207, Aug. 11, 1998; U.S. Pat. No. 6,052,671 issued Apr. 18, 2000; U.S. Pat. No. 6,038,548 issued Mar. 14, 2000; and U.S. Pat. No. 6,070,150 issued May 30, 2000 (collectively the “listed patents”)—(all of which listed patents are incorporated herein in the entirety for all purposes) said preferred embodiments according to the present invention including any method in any of these listed patents plus one or some (in any number and in any possible combination) of the elements of the present invention, including, but not limited to, one or some of these elements of certain embodiments of the present invention:

guaranteeing a consumer a best price on an item or service purchased from a vendor in a first transaction at a first price

recording the first price and information identifying the consumer

monitoring sales prices of the item or service for a predetermined time period after the first transaction; the monitoring of sales prices including, but not limited to, monitoring regular prices, discount prices, on-sale prices, and clearance prices

noting any sales price of the item or service lower than the first price during the predetermined time period

calculating a money-value difference between the first price and said any price lower than the first price

refunding to the consumer an amount equal to the money-value difference

recording the first price and information identifying the consumer, monitoring the sales price of the item or service for a predetermined time period after the first transaction, noting any price lower than the first price for the item or service during the predetermined time period, calculating a money-value difference between the first price and said any price lower than the first price, and refunding to the consumer an amount equal to the money-value difference

wherein the item or service is purchased by the consumer at a location of the vendor.

wherein the item or service is purchased by the consumer on-line via a network system

wherein the item or service is purchased via a host system and the host system records the first price and information identifying the customer; the host system conducts the monitoring, noting, and calculating steps; and the host system provides the refund to the consumer

wherein the host system provides the refund by crediting an account of the consumer

wherein the account is an account of the consumer with the host system

wherein a refund is made for each subsequent sales price lower than the first price

wherein the consumer conducts the first transaction with the vendor via the host system

monitoring sales of the item or service during the predetermined time period for any incentive provided to consumers purchasing the item or service following the first transaction, and providing the consumer involved in the first transaction with a refund based on a money value of said incentive

monitoring sales of the item or service during the predetermined time period for any incentive provided to consumers purchasing the item or service following the first transaction, and providing the consumer involved in the first transaction with a refund based on a money value with said incentive

wherein only prices for the item or service to be sold by the vendor involved in the first transaction are taken into account in the noting step

wherein only prices for the item or service for sale in a pertinent geographic area are taken into account in the noting step

It is within the scope of the present invention to provide a system that includes any system from the listed patents with one or some (in any possible combination) of the following:

system for guaranteeing a consumer a best price on an item or service purchased from a vendor in a first transaction at a first price, the system including apparatus, computers, machines and/or devices for recording the first price and information identifying the consumer, for monitoring the sales price of the item for a predetermined time period after the first transaction, for noting any price lower than the first price for the item during the predetermined time period, for calculating a money-value difference between the first price and said any price lower than the first price, and for refunding to the consumer an amount equal to the money-value difference

a host system that includes the apparatus, etc. for recording, for monitoring, for noting, and for calculating.

the host system also including the apparatus, etc. for refunding

for duplicating for the consumer any incentive accompanying sales of the item after the first transaction during the predetermined time period

for determining a pertinent geographic area for the first transaction and for limiting the monitoring step to sales prices available within the pertinent geographic area

for providing a warranty to the consumer.

for alerting the consumer to possible warranties, warranty extensions, and/or warranty renewals, and/or

for the consumer to apply for such a warranty, warranty extension, and/or warranty renewal

### Improved Versions of U.S. Pat. No. 6,014,634

The present invention, in certain aspects provides improved versions of the subject matter of U.S. Pat. No. 6,014,634, (incorporated fully here for all purposes) including, but not limited to: including for each method of the patent guaranteeing a best price according to the present invention; a computer implemented method for determining purchasing incentives for consumers, including the steps of: storing in a purchase history database product data for products purchased in association with a unique identifier, transmitting a prompt for personal information from a main computer to a personal computer over a computer network, transmitting personal information data from said personal computer to said main computer over said computer network in response to said prompt, said personal information data including an identity code, generating page data defining a personal web page that is accessible over said computer network, said personal web page based at least in part on said personal information data transmitted from said personal computer to said main computer, assigning a web page address to said personal web page based upon said personal information data, storing said page data defining said personal web page in a personal page database, determining a purchase incentive depending on (1) said product data stored in said purchase history database or (2) said page data stored in said personal page database, updating said page data so that said personal web page will display said purchase incentive guaranteeing a best price according to the present invention for the purchased products and, in one aspect, effecting such guaranteeing by

recording the first price and information identifying the consumer

monitoring sales prices of the item or service for a predetermined time period after the first transaction

noting any sales price of the item or service lower than the first price during the predetermined time period

calculating a money-value difference between the first price and said any price lower than the first price

refunding to the consumer an amount equal to the money-value difference;

The present invention also provides an improved system (as compared to systems of U.S. Pat. No. 6,014,634) for providing purchasing incentives to consumers, including a main computer having a purchase history database for storing product data for products purchased in association with a unique identifier and a personal page database, a computer network, at least one personal computer coupled to said main computer via said computer network, said main computer configured to transmit a prompt for personal information to said at least one personal computer over said computer network, said at least one personal computer configured to transmit personal information data from to said main computer over said computer network in response to said prompt, said main computer configured to generate page data defining a personal web page that is accessible over said computer network, said personal web page based at least in part on said personal information data transmitted from said at least one personal computer to said main computer, said main computer configured to assign a web page address to said personal web page based upon said personal information data, said main computer configured to store said page data defining said personal web page in said personal page database, said main computer configured to determine a purchase incentive depending on (1) said product data stored in said purchase history database or (2) said page data stored in said personal page database, said main computer configured to update said page data so that said personal web page will display said purchase incentive, and the main computer configured to carry out the steps of the guaranteeing of the best price for the purchased products; a computer program product including a computer storage medium having a computer program therein for providing purchasing incentives to consumers, said computer program performing the steps of storing in a purchase history database product data for products purchased in association with a unique identifier, transmitting a prompt for personal information from a main computer to a personal computer over a computer network, transmitting personal information data from said personal computer to said main computer over said computer network in response to said prompt, generating page data defining a personal web page that is accessible over said computer network, said personal web page based at least in part on said personal information data transmitted from said personal computer to said main computer, assigning a web page address to said personal web page based upon said personal information data, storing said page data defining said personal web page in a personal page database, determining a purchase incentive depending on (1) said product data stored in said purchase history database or (2) said page data stored in said personal page database, updating said page data so that said personal web page will display said purchase incentive, and the steps of guaranteeing of the best price for the purchased products; a computer implemented method for generating a web page said method including the steps of transmitting a prompt for personal information from a main computer to a personal computer over a computer network, transmitting personal information data from said personal computer to said main computer over said computer network in response to said prompt, generating page data defining a web page based upon said personal information data, assigning a web page address to said web page based upon said personal information data, storing in a purchase history database data identifying products purchased in association with said identity code, determining a purchase incentive depending on said data stored in said purchase history database in association with said identity code, changing said page data so that said web page having said web page address displays said purchase incentive, and the steps of guaranteeing the best price for the purchased products; and a computer implemented method for generating a web page, said method including the steps of transmitting a prompt for personal information from a main computer to a personal computer over a computer network, transmitting personal information data from said personal computer to said main computer over said computer network in response to said prompt, generating page data defining a web page based upon said personal information data, assigning a web page address to said web pane based upon said personal information data, determining a purchase incentive depending on said personal information, changing said page data so that said web page having said web page address displays said purchase incentive, and guaranteeing a best price for the purchased products.

### Improved Versions of U.S. Pat. No. 6,014,635

The present invention, in certain aspects, provides improved versions of the subject matter of U.S. Pat. No. 6,014,635 (incorporated fully here for all purposes) including, but not limited to: a method for providing a discount for a credit transaction, for use in a discount credit network comprising a plurality of transaction card issuers each having a plurality of participants holding a transaction card account issued by the card issuer, the method including assigning each participant a membership number wherein the membership number is associated with the particular participant's transaction card account, providing a computerized discount authorization processor operatively connected to the discount credit network including (1) a database containing the membership numbers and their associated transaction card accounts, and (2) processing means for correlating the membership numbers to their associated transaction card accounts and transaction card issuers, presenting, by the participant, the membership number to an authorized merchant for a transaction, issuing a first discount authorization request from said authorized merchant through the discount credit network to the discount authorization processor, wherein the first discount authorization request includes transaction data comprising the particular participant's membership number and an amount for the transaction, correlating the membership number to its associated transaction card account and transaction card issuer, issuing a second discount authorization request to the transaction card issuer associated with the transaction card account through the credit network, the second discount authorization request comprising the particular participant's transaction card account and the amount of the transaction, receiving, by the discount authorization processor, an authorization response signal from the transaction card issuer, said signal indicating a response to the proposed transaction, forwarding the authorization response signal to the authorized merchant, and for each item or service which is the subject of any of said transactions guaranteeing a best price according to the present invention for said item or service, and, in certain aspects, guaranteeing the best price by recording the first price and information identifying the consumer, monitoring sales prices of the item or service for a predetermined time period after the first transaction, noting any sales price of the item or service lower than the first price during the predetermined time period, calculating a money-value difference between the first price and said any price lower than the first price, refunding to the consumer an amount equal to the money-value difference.

### Improved Versions of U.S. Pat. No. 6,014,636

The present invention, in certain aspects, provides improved versions of the subject matter of U.S. Pat. No. 6,014,636 (incorporated fully here for all purposes) including, but not limited to: including in each method of U.S. Pat. No. 6,014,636 guaranteeing a best price according to the present invention for the item or service that is the subject of the customer payment and including in each apparatus or system of U.S. Pat. No. 6,014,636 the apparatus(es), computer(s), network(s), device(s), machine(s), and/or computer program(s) for accomplishing the steps associated with guaranteeing the best price.

### Improved Versions of U.S. Pat. No. 6,006,199

The present invention, in certain aspects, provides improved versions of the subject matter of U.S. Pat. No. 6,006,199 (incorporated fully here for all purposes) including, but not limited to: including in each method of U.S. Pat. No. 6,006,199 guaranteeing a best price according to the present invention and in each system of the patent the apparatus(es), computer(s), network(s), device(s), machine(s), and/or computer program(s) for accomplishing the guaranteeing of the best price.

### Improved Versions of U.S. Pat. No. 6,006,205

The present invention, in certain aspects, provides improved versions of the subject matter of U.S. Pat. No. 6,006,205 (incorporated fully here for all purposes) including, but not limited to: including in each method of U.S. Pat. No. 6,006,205 guaranteeing a best price according to the present invention and in each system or device of the patent the apparatus(es), computer(s), network(s), device(s), machine(s), and/or computer program(s) for accomplishing the guaranteeing of the best price, and in certain aspects, the processor operative with the program to accomplish the steps of guaranteeing the best price.

### Improved Versions of U.S. Pat. No. 6,009,408

The present invention, in certain aspects, provides improved versions of the subject matter of U.S. Pat. No. 6,009,408 (incorporated fully here for all purposes) including, but not limited to: including in each method of U.S. Pat. No. 6,009,408 guaranteeing a best price according to the present invention for any or all transactions and in each system of the patent the apparatus(es), computer(s), network(s), device(s), machine(s), and/or computer program(s) for accomplishing the guaranteeing of the best price for any or all transactions.

### Improved Versions of U.S. Pat. No. 6,009,411

The present invention, in certain aspects, provides improved versions of the subject matter of U.S. Pat. No. 6,009,411 (incorporated fully here for all purposes) including, but not limited to: including in each method of U.S. Pat. No. 6,009,411 guaranteeing a best price according to the present invention for any or all purchased items and in each system of the patent the apparatus(es), computer(s), network(s), device(s), machine(s), and/or computer program(s) for accomplishing the guaranteeing of the best price.

### Improved Versions of U.S. Pat. No. 6,009,413

The present invention, in certain aspects, provides improved versions of the subject matter of U.S. Pat. No. 6,009,413 (incorporated fully here for all purposes) including, but not limited to: including in each method of U.S. Pat. No. 6,009,413 guaranteeing a best price according to the present invention for any purchased product and in each system of the patent the apparatus(es), computer(s), network(s), device(s), machine(s), and/or computer program(s) for accomplishing the guaranteeing of the best price.

### Improved Versions of U.S. Pat. No. 5,995,942

The present invention, in certain aspects, provides improved versions of the subject matter of U.S. Pat. No. 5,995,942 (incorporated fully here for all purposes) including, but not limited to: including in each method of U.S. Pat. No. 5,995,942 guaranteeing a best price according to the present invention and in each system of the patent the apparatus(es), computer(s), network(s), device(s), machine(s), and/or computer program(s) for accomplishing the guaranteeing of the best price.

### Improved Versions of U.S. Pat. No. 5,999,919

The present invention, in certain aspects, provides improved versions of the subject matter of U.S. Pat. No. 5,999,919 (incorporated fully here for all purposes) including, but not limited to: including in each method of U.S. Pat. No. 5,999,919 guaranteeing a best price according to the present invention for any item or service which is the subject of a transaction and in each system of the patent the apparatus(es), computer(s), network(s), device(s), machine(s), and/or computer program(s) for accomplishing the guaranteeing of the best price.

### Improved Versions of U.S. Pat. No. 5,999,914

The present invention, in certain aspects, provides improved versions of the subject matter of U.S. Pat. No. 5,999,914 (incorporated fully here for all purposes) including, but not limited to: including in each method of U.S. Pat. No. 5,999,914 guaranteeing a best price according to the present invention for the subject of an order and in each system of the patent the apparatus(es), computer(s), network(s), device(s), machine(s), and/or computer program(s) for accomplishing the guaranteeing of the best price.

### Improved Versions of U.S. Pat. No. 5,991,739

The present invention, in certain aspects, provides improved versions of the subject matter of U.S. Pat. No. 5,991,739 (incorporated fully here for all purposes) including, but not limited to: including in each method of U.S. Patent guaranteeing a best price according to the present invention and in each apparatus or system of the patent the apparatus(es), computer(s), network(s), device(s), machine(s), and/or computer program(s) for accomplishing the guaranteeing of the best price.

### Improved Versions of U.S. Pat. No. 5,895,454

The present invention, in certain aspects, provides improved versions of the subject matter of U.S. Pat. No. 5,895,454 (incorporated fully here for all purposes) including, but not limited to: including in each method of U.S. Pat. No. 5,895,454 guaranteeing a best price according to the present invention for any product or service purchased and in each system of the patent the apparatus(es), computer(s), network(s), device(s), machine(s), and/or computer program(s) for accomplishing the guaranteeing of the best price.

### Improved Versions of U.S. Pat. No. 5,960,411

The present invention, in certain aspects, provides improved versions of the subject matter of U.S. Pat. No. 5,960,411 (incorporated fully here for all purposes) including, but not limited to: including in each method of U.S. Patent guaranteeing a best price according to the present invention for any item purchased and in each system of the patent the apparatus(es), computer(s), network(s), device(s), machine(s), and/or computer program(s) for accomplishing the guaranteeing of the best price.

### Improved Versions of U.S. Pat. No. 5,991,738

The present invention, in certain aspects, provides improved versions of the subject matter of U.S. Pat. No. 5,991,738 (incorporated fully here for all purposes) including, but not limited to: including in each method of U.S. Pat. No. 5,991,738 guaranteeing a best price according to the present invention for any item or service purchased and in each system of the patent the apparatus(es), computer(s), network(s), device(s), machine(s), and/or computer program(s) for accomplishing the guaranteeing of the best price.

### Improved Versions of U.S. Pat. No. 5,794,207

The present invention, in certain aspects, provides improved versions of the subject matter of U.S. Pat. No. 5,794,207 (incorporated fully here for all purposes) including, but not limited to: including in each method of U.S. Pat. No. 5,794,207 guaranteeing a best price according to the present invention for any item or service purchased, and in each system of the patent the apparatus(es), computer(s), network(s), device(s), machine(s), and/or computer program(s) for accomplishing the guaranteeing of the best price.

### Improved Versions of U.S. Pat. No. 6,018,717

The present invention, in certain aspects, provides improved versions of the subject matter of U.S. Pat. No. 6,018,717 (incorporated fully here for all purposes) including, but not limited to: including in each method of U.S. Pat. No. 6,018,717 guaranteeing a best price according to the present invention for any item or service purchased, and in each system of the patent the apparatus(es), computer(s), network(s), device(s), machine(s), and/or computer program(s) for accomplishing the guaranteeing of the best price. In one particular aspect, a method according to the present invention is a method for using a smart card to gain access through an access device upon payment of a value (V) as payment for a thing or service sold at a first price, the method including: operatively coupling said smart card to said access device; reading at least a first set of data and a second set of data from said smart card; performing a first authentication process on said at least first set of data; permitting access if said step of performing a first authentication process meets a required condition; storing said at least first set of data and said second set of data in a memory of said access device when access is permitted, wherein when access is not permitted, said at least first set of data and said second set of data are not stored in said memory of said access device; performing a second authentication process on said at least first set of data and said second set of data after said step of permitting access is accomplished; and guaranteeing a best price for the thing or service purchased initially at the first price.

In one particular aspect of the present invention, a method is provided for guaranteeing the best price for the delivery of a mail item (e.g. a letter, parcel, package, box, postcard). Any method disclosed herein for guaranteeing a best price for a service may be used to guarantee a best price for mail delivery service. One particular method for guaranteeing a consumer a best price for mail delivery service for delivering a mail item delivered by a first mail service provider in a first transaction at a first price includes recording the first price and information identifying the consumer, monitoring the sales price of the item for a predetermined time period after the first transaction, noting any price lower than the first price for the service during the predetermined time period, calculating a money-value difference between the first price and said any price lower than the first price, and refunding to the consumer an amount equal to the money-value difference. For multiple subsequent lower prices a largest single money-value difference for the largest first-price/subsequent price differential is determined and that amount is refunded.

The present invention, therefore, discloses in at least certain embodiments, a computer implemented method for guaranteeing a consumer a best price on an item or service purchased from a vendor in a first transaction at a first time at a first price. Such a method may include storing in a first database data for the first price and information identifying the consumer, inputting at least one second price for the item or service, said second price comprising a price charged for the item or service at a time later than the first time, determining, during a predetermined time period, any price of the at least one second price lower than the first price for the item, comparing the first price to the at least one second price and calculating a money-value difference between the first price and any price of the at least one second price lower than the first price, and refunding to the consumer a refund amount equal to the money-value difference. Such a method may include one or some (in any possible combination) of the following: wherein the refunding step includes posting the refund amount as a credit to an account of the consumer; wherein the item or service is purchased by the consumer on-line via a network system; wherein the item is purchased via a host system with at least one computer for implementing the computer implemented method and the host system records the first price and information identifying the customer; the host system conducts the monitoring, noting, and calculating steps; and the host system provides the refund to the consumer; wherein the host system provides the refund by crediting an account of the consumer; wherein the account is an account of the consumer with the host system; wherein a refund adjustment is made for each subsequent sales price lower than the at least one second price for the predetermined time period; monitoring sales of the item or service during the predetermined time period for any incentive provided to consumers purchasing the item or service following the first transaction, and providing the consumer involved in the first transaction with a refund based on a money value of said incentive; monitoring sales of the item or service during the predetermined time period for any incentive provided to consumers purchasing the item following the first transaction, and

providing the consumer involved in the first transaction with a refund based on a money value of said incentive; wherein only prices for the item to be sold by the vendor involved in the first transaction are taken into account in the comparing step; and/or wherein only prices for the item for sale in a pertinent geographic area are taken into account in the comparing step.

The present invention, therefore, discloses in at least certain embodiments, a computer program product comprising a computer storage medium having a computer program therein for guaranteeing a consumer a best price of an item or service purchased at a first price from a vendor in a first transaction at a first time, said computer program performing the steps of receiving and storing in a first database data for the first price with a unique identifier identifying the consumer, receiving and storing in a second database at least one second price for the item or service, said second price comprising a price charged for the item or service at a time later than the first time, determining, during a predetermined time period, any price of the at least one second price lower than the first price, comprising the first price to the at least one second price, calculating a money-value difference between the first price and the at least one second price lower than the first price, and generating a refund amount equal to the money-value difference. Such a computer program may include one or some (in any possible combination) of the following: crediting an account of the consumer with the refund amount; crediting the consumer's account by transmitting data indicative of the refund amount and data identifying the consumer from a first computer to a second computer, the second computer maintaining the account of the consumer; said at least one second price lower than the first price comprising a plurality of said second prices, the computer program further including determining the lowest price of the plurality of said second prices and generating a refund amount corresponding to a largest money-value difference between said lowest price and said first price, and generating a refund amount equal to said largest money-value difference; and/or crediting an account of the consumer with the largest money-value difference.

The present invention, therefore, discloses in at least certain embodiments, an apparatus for guaranteeing a best price to a consumer for an item or service purchased at a first price at a first time from a vendor in a first transaction, the apparatus including a storage device and a processor device connected to the storage device, the storage device storing a program for controlling the processor, the processor operative to: compare the first price to at least one subsequent second price for the item or service, determine whether the at least one subsequent second price is lower than the first price, and, if so, calculate a money-value difference between the first price and the at least one subsequent second price which is lower than the first price, and generate a refund amount equal to the money-value difference. Such an apparatus may include one or some (in any possible combination) of the following: credit an account of the consumer with the refund amount; wherein the processor is operative to credit the consumer's account by transmitting data indicative of the refund amount and data identifying the consumer from a first computer to a second computer, the second computer maintaining the account of the consumer; wherein data for the account of the consumer is stored in the storage device; wherein said at least one second price lower than the first price comprising a plurality of said second prices, the processor operative to determine the lowest price of the plurality of said second prices and a refund amount corresponding to a largest money-value difference between said lowest price and said first price, and generate a refund amount equal to said largest money-value difference; and/or wherein the processor is operative to credit an account of the consumer with the largest money-value difference.

### Improved Versions of U.S. Pat. No. 6,038,548

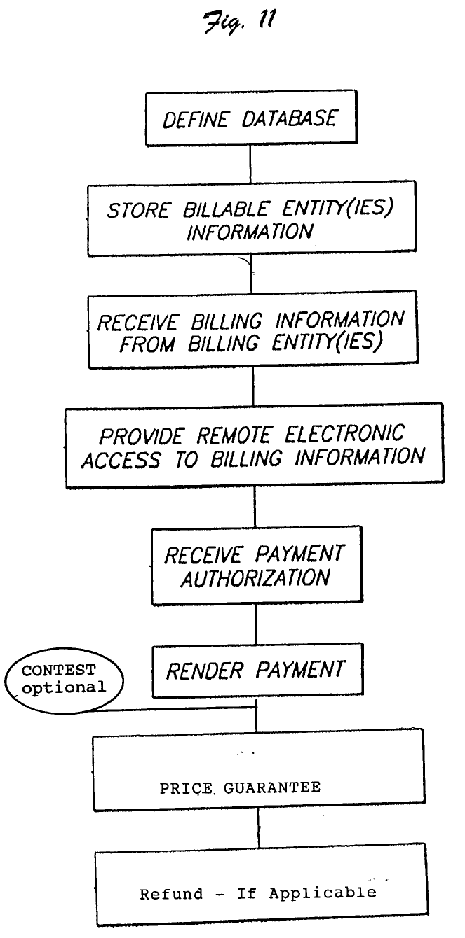

The present invention, in certain aspects, provides improved versions of the subject matter of U.S. Pat. No. 6,038,548 (incorporated fully here for all purposes) including, but not limited to: including in each method of U.S. Pat. No. 6,038,548 guaranteeing a best price according to the present invention for a transaction (e.g. with transaction subject matter including any item or service purchased), and in each network, method, system and/or article of manufacture of the patent the apparatus(es), computer(s), network(s), device(s), machine(s), computer programming code, and/or computer program(s) for accomplishing the guaranteeing of the best price. In one particular aspect, a method according to the present invention is a method for implementation with a computer network that includes a plurality of user workstations coupled to a network server containing a collection of replaceable and extensible object-oriented software components that interoperate to provide back-end services, the method for conducting electronic commerce between a user and an electronic commerce merchant and including the steps of: a) generating an implementation of an abstract, object-oriented Cashier Component to process payment requests by employing a number of replaceable software components or tools in a framework; b) generating an implementation of an abstract, object-oriented CashierDesk component that provides the Cashier component access to instances of other classes used in processing a transaction; c) entering a transaction into the Cashier component for processing for payment and issuing of a receipt for the transaction using the CashierDesk components; and d) guaranteeing a best price to the user for the transaction. Such a method is illustrated diagrammatically in FIG. 10 (all items of which, except lines 140 and 150, are described in U.S. Pat. No. 6,038,548, incorporated here by reference; herein a numeral “3” prefix is added to each numeral from U.S. Pat. No. 6,038,548, e.g. component 113 here is component 13 in U.S. Pat. No. 6,038,548). Numeral 140 indicates the monitoring of subsequent prices at a time or times T10 for the transaction's subject matter, etc., according to the present invention to guarantee a best price to the user for the transaction. Numeral 150 indicates a refund at a time T11 if such is necessitated by the best price guarantee. An arrow from the “Cashier 113” indicates that in this particular embodiment the Cashier component 113 includes computer programming code and apparatus for conducting the various steps to effect the best price guarantee; but it is within the scope of this invention for them to be in any appropriate computer and/or accessible via a network, e.g. the Internet.

### Improved Versions of U.S. Pat. No. 6,052,671

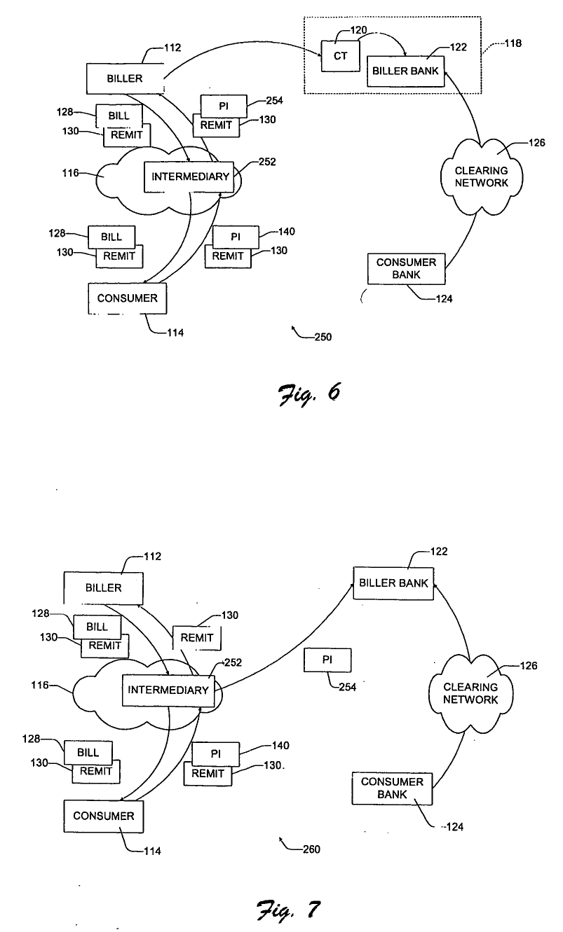

The present invention, in certain aspects, provides improved versions of the subject matter of U.S. Pat. No. 6,052,671 (incorporated fully here for all purposes) including, but not limited to: including in each method of U.S. Pat. No. 6,052,671 guaranteeing a best price according to the present invention for any item or service purchased, and in each system of the patent the apparatus(es), computer(s), network(s), device(s), machine(s), and/or computer program(s) for accomplishing the guaranteeing of the best price. In one particular aspect, a method according to the present invention is a method as shown schematically in FIG. 4 that is a billing and payment authorization method that includes: defining a database having predetermined tolerance parameters for a billable entity; receiving billing information from a billing entity, the billing information including an amount the billable entity is to pay for goods or services; after receiving the billing information, determining if the billing information received from the billing entity satisfies the predetermined tolerance parameters; providing the billable entity with remote access to the database to review the billing information submitted by the billing entity, and authorize payment of the billing entity; guaranteeing a best price to the billable entity for the goods or services which the payment is form, and, if necessary, providing a refund to the billable entity (which, in one aspect, is automatically credited to an account of the billable entity with no action or initiation by the billable entity. All the boxes of FIG. 11 are described in U.S. Pat. No. 6,052,671 which is incorporated here by reference, except the bottom two boxes.

### Improved Versions of U.S. Pat. No. 6,070,150

The present invention, in certain aspects, provides improved versions of the subject matter of U.S. Pat. No. 6,070,150 (incorporated fully here for all purposes) including, but not limited to: including in each method of U.S. Pat. No. 6,070,150 guaranteeing a best price according to the present invention for any item or service purchased, and in each system of the patent the apparatus (es)., computer(s), network(s), device(s), machine(s), and/or computer program(s) for accomplishing the guaranteeing of the best price.

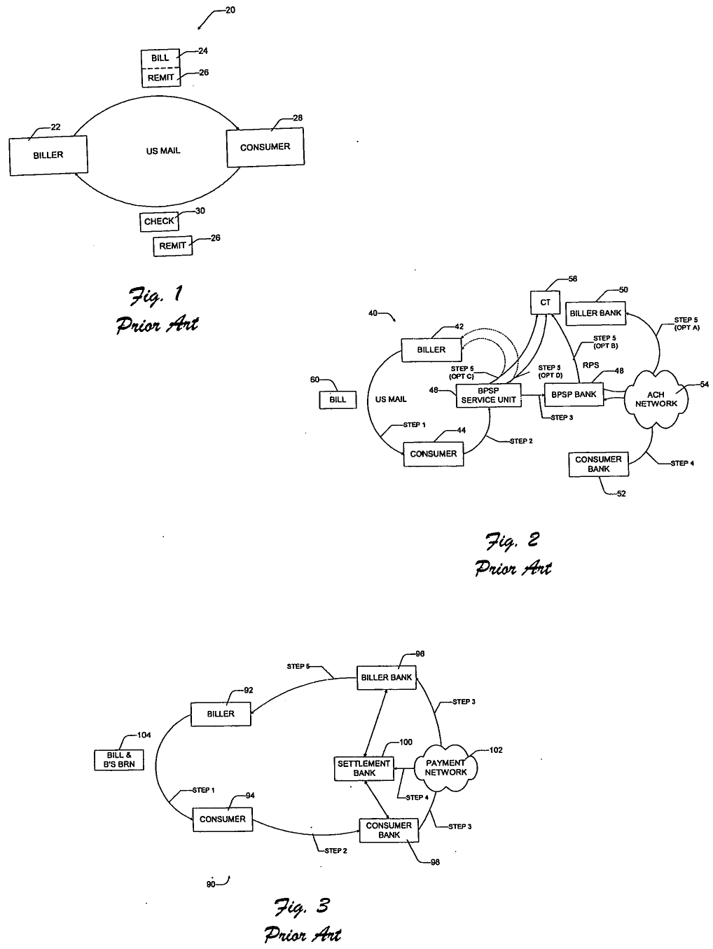

The term “consumer” is used here to represent both a typical person consuming goods and services as well as a business consuming goods and services. FIG. 1 shows a traditional prior art paper-based bill presentment and remittance system 20. At the end of a billing cycle, a biller 22 generates a bill 24 for each consumer account having a positive or negative account balance, or transactions in the billing cycle which yielded a zero balance. As used herein, a “biller” is any party that originates bills or statements for goods or services rendered to the consumer. Examples of billers are: utilities, government, merchants, and intermediate billing services such as banks.

In addition to the bill, the biller 22 creates remittance information 26 which associates the bill and any payment toward the bill with the consumer account. The remittance information 26 usually includes an account number, an account balance, an amount due, the date due, and any additional data that the biller might need to link the payment to the account. The remittance information 26 is typically in the form of a detachable stub or coupon which the consumer is requested to detach from the bill statement and return along with the payment.

The biller 22 prints the bill 24 and remittance information 26 on a paper statement, encloses the statement in an envelope, and mails the envelope to a consumer 28 using the U.S. postal service. The phase concerning preparation and mailing of the bill is referred to as the “bill presentment” phase.

To pay the bill, the consumer 28 usually writes a check 30 which directs payment to the biller 22. The payment may partially or fully satisfy the amount due in the bill. The consumer 28 also fills out payment information on the remittance stub 26, such as amount paid, payment date, and account number (if not already on the stub). The consumer 28 encloses the stub 26 and check 30 in an envelope (often, pre-addressed) and mails it back to the biller using, once again, the U.S. postal service.

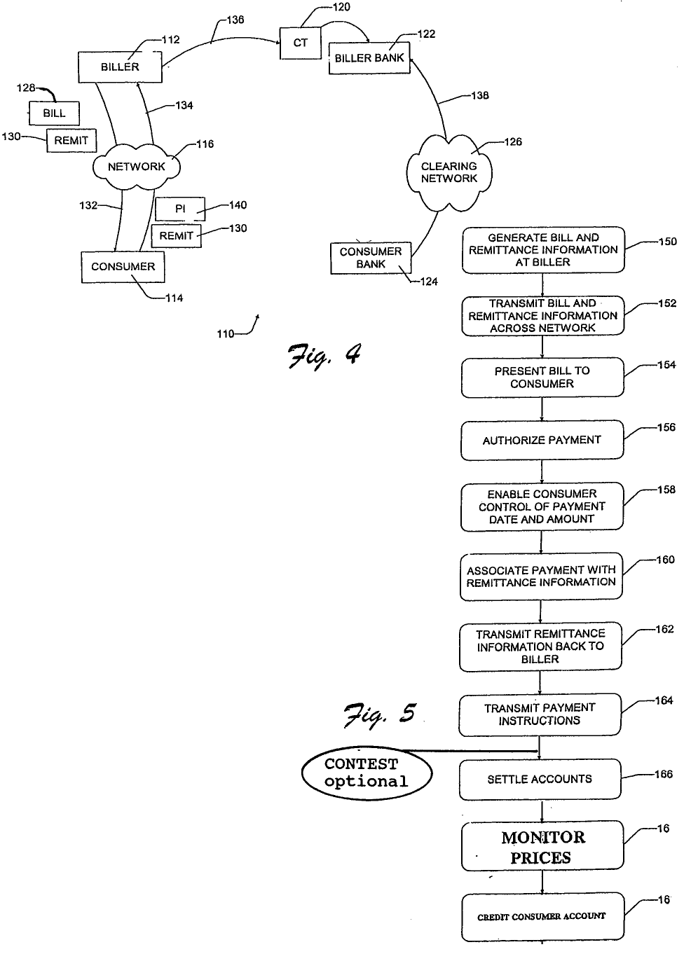

FIG. 2 shows a prior art electronic Bill Payment Service Provider (BPSP) system 40 operated by companies like CheckFree Corporation, Intuit Services Corporation, and VISA Interactive. The BPSP system 40 includes a biller 42, a consumer 44, a BPSP services unit (BSU) 46, BPSP bank 48, a biller bank 50, a consumer bank 52, and ACH (Automated Clearing House) network 54, and potentially other payment networks like RPS (Remittance Processing Service). The lockbox operation of processing payment remittances is performed by either the biller, or a third party designated by the biller. In the illustrated implementation, a third party concentrator (CT) 56 processes payment remittances, although the bank 50 itself may also be designated to perform the lockbox operation. The ACH network is a nationwide system that processes electronic payments on behalf of depository financial institutions well-known in the art.

The methods for presenting and paying bills via existing BPSP systems 40 is illustrated as a series of enumerated steps. The biller 42 sends a paper bill 60 through the US mail to the consumer 44 (step 1). To pay the bill 60, the consumer 44 sends payment instructions to the BPSP services unit 46 by computer, or by telephone using an interactive voice response system (step 2). At this point, the BPSP services unit 46 has several choices:

1. Laser Draft. Print a laser demand check drawn on the consumer's account at the consumer bank 52 and send the laser demand check to the biller 42 or concentrator 56. This process is illustrated as step 5, option D.

2. Partial Electronic. With this choice, the consumer account is debited via the ACH network 54 (step 4), but payment is remitted using a check—either a bunch of payments lumped together as a check and list (step 5, Option C) or a single payment drawn on the BPSP bank account for the amount the consumer owes the biller (step 5, Option D).

3. Full Electronic. The consumer account is debited via the ACH network 54 (step 4) and payment is made via the ACH network (Step 5, Option A) or other network, such as the RPS network (step 5, Option B).

U.S. Pat. No. 5,383,113 to Kight et al., which is assigned to CheckFree Corporation, describes a system and method for determining which of the three choices to make for different situations.

Assuming that a choice for partial or full electronic payment is made, the BPSP services unit 46 prepares ACH-ready and other payment instructions to its bank 48 (step 3). Using the ACH instructions, an ACH debit transaction from the consumer bank account 52 is performed through the ACH network 54 (step 4). This ACH debit transaction effectively moves the authorized finds from the consumer bank account 52 to the BPSP bank 48.

At this point, a number of different options can be taken to transfer payment from the BPSP bank 48 to the biller bank 50 or the concentrator 56. One possibility is to perform an ACH credit transaction through the ACH network 54 from the BPSP account at bank 48 to the biller bank account 50 (step 5—option A). Another possibility is to perform an RPS credit transfer from the BPSP account at bank 48 to the biller bank account 50 or concentrator 56 (step 5—option B). A third option is for the BPSP bank 48 to produce a single aggregated check drawn on the BPSP account and a list of all consumers making payments, and to send the check and list to the biller 42 or concentrator 56 (step 5—option C).

FIG. 3 shows a prior art electronic bill payment system 90 proposed by Visa International. This system 90 is described in U.S. Pat. No. 5,465,206, entitled “Electronic Bill Pay System” issued Nov. 7, 1995. The Visa system 90 includes a biller 92, a consumer 94, a biller bank 96, a consumer bank 98, a settlement bank 100, and a payment network 102. The payment network 102 is described in the patent as being the VisaNet.RTM. network. A method for presenting and paying bills using the Visa bill pay system 90 is illustrated as a series of enumerated steps. The biller 92 sends a bill 104 by U.S. mail or email (step 1). The bill 104 includes a unique biller reference number (BRN). To pay the bill 104, the consumer 94 transmits to consumer bank 98 a transaction indicating an amount to pay, the source of funds, a date on which to make the payment, the consumer's account number with biller, and the biller's BRN (step 2).

The consumer bank 98 submits an electronic payment message to biller bank 96 via the payment network 102 (step 3). The payment message includes a bank identification number for consumer bank 98, a bank identification number for biller bank 96, the biller's BRN, the consumer's account number with biller, an amount to be paid, and an implicit guarantee of consumer bank 98 to provide funds to cover payment.

Settlement is achieved using the standard processes over the payment network, and particularly, via the VisaNet.RTM. network for Visa sponsoring banks and the RPS network for non-Visa sponsoring banks (step 4). After settlement, the biller bank 96 passes an accounts receivable (A/R) file to the biller 92 to indicate which payments were received by the biller bank on behalf of the biller (step 5). The A/R file lists individual payments received in correlation to the consumer accounts numbers. The remittance information flows from the consumer 94 directly to the consumer bank 98, then over a highly structured payment network 102 having strict rules as to format, content, timing, and so forth, and then onto the biller bank 96. As a result, the biller bank 96 only receives the data supported by the VisaNet.RTM. network, and is thus restricted to only this data for inclusion in the A/R file to be downloaded to the biller.

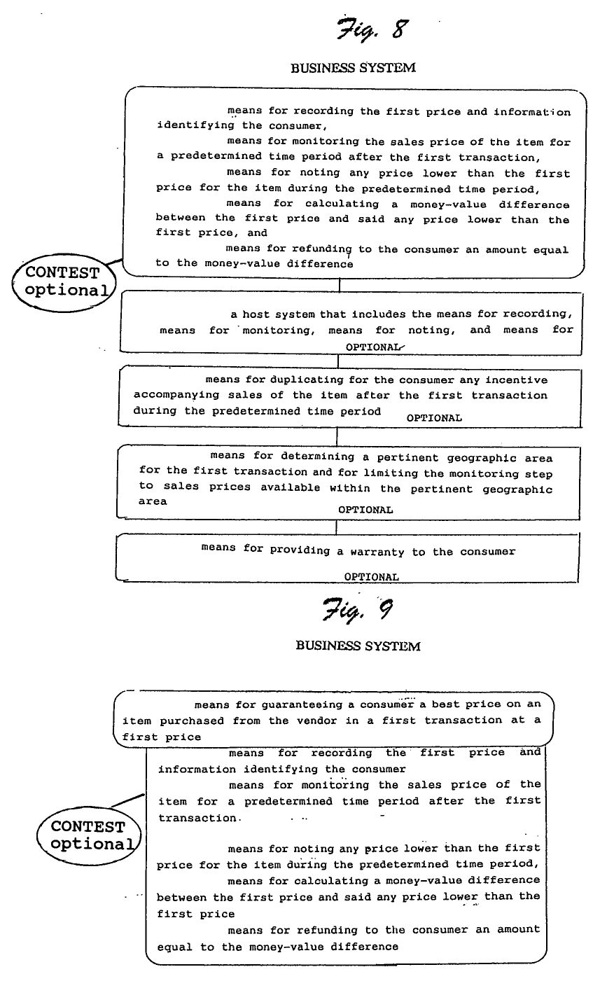

FIG. 4 shows a bill presentment and payment remittance & settlement system 110 according to an implementation of this invention. The system 110 includes a biller 112, a consumer 114, and a network 116. The bill presentment and payment system 110 is an electronic, computerized system having computing units at the biller 112 and consumer 114. For convenience, the pair of terms “biller” and “biller computing unit,” as well as the pair of terms “consumer” and “consumer computing unit,” will be used interchangeably. A detailed discussion of an exemplary implementation of a consumer computing unit is described below and depicted in FIG. 6.

The network 116 is an electronic data network. One preferred implementation is a public network, and particularly, the Internet. The Internet is a network formed by the cooperative interconnection of computing networks, including local and wide area networks. It interconnects computers from around the world with existing and even incompatible technologies by employing common protocols that smoothly integrate the individual and diverse components.

The bill presentment and payment system 110 includes a biller bank 122 that maintains the biller's account. In this implementation, a concentrator 120 is also illustrated to perform the lockbox operations. The lockbox functions can be performed by either the biller or a third party designated by the biller, such as the biller bank, a different bank, or another non-bank entity. The bill and presentment system 110 further includes a consumer bank 124 which manages the consumer's account. Other depository financial institutions wherein the consumer has an account, such as a brokerage firm with checking privileges, may be substituted for the consumer bank 124 within this system. The biller bank 122 and consumer bank 124 are connected to a clearing network 126, such as the ACH network.

FIG. 5 shows a method for electronically presenting and paying bills using the system 110. As one implementation, the steps are performed in software executing at the biller computing unit 112 and the consumer computing unit 114. Other software components might also reside at the biller bank 122 (and/or concentrator 120) and the consumer bank 124. At step 150, the biller's software executing at the biller computing unit 112 generates a bill 128 and associated payment remittance information 130 according to a format created entirely by the biller. This is advantageous because the biller can customize the bill and remittance information to include any type of data that it wants. Additionally, the bill and payment remittance information can be specifically formatted for compatibility with the biller's existing accounting software. Another advantage is that the bill can be artistically designed to present an appearance unique to the biller. The bill 128 might be implemented simply as a static data structure which holds pertinent data related to the account and billing matters, as well as any remittance data desired by the biller. This data structure is passed between the biller computing unit and the consumer computing unit and utilized by the software components running on these computing units. The bill 128 might alternatively be constructed with additional features, such as embedded hyperlinks, pop-up dialog boxes, or pop-up advertisements. The bill 128 might further be constructed as a sophisticated application, having executable code and other features, in addition to the basic data structure.

At step 152 in FIG. 5, the biller computing unit 112 sends the bill 128 and payment remittance information 130 across the public network 116 to the consumer computing unit 114 (as illustrated by arrow 132 in FIG. 4). The biller computing unit 112 can also include non-billing materials to the bill, such as regulatory notices, warnings, or advertisements. The biller computing unit 112 might optionally digitally sign the bill and payment remittance information before transmission. A digital signature is often used to verify the source of information on a network such as the Internet.

The consumer computing unit 114 receives the bill 128 and remittance information 130 from the network 116. In one implementation, the bill and remittance information arrive in the form of an email message or a notification for the consumer to check a billing mailbox to retrieve electronic bills. A bill presentment and payment software application residing on the consumer computing unit 114 is opened to facilitate presenting and paying the bill. This application might be opened automatically upon receipt of the bill, or in response to the consumer activating the bill email message (for example, by using a mouse to point to and double left-click on the bill message). The consumer computing unit 114 might further be configured to authenticate the biller's signature, if one is attached, to ensure that the bill is truly from the biller and not an impostor trying to covertly extract money from the consumer.

At step 167, FIG. 5, the biller computing unit 112 (or any other computing unit or suitable system in the overall system) may be used to monitor the Network 116 (or any other desired Network or database) for prices for the goods or services purchased by the consumer. The unit 112 can compute price differences and applicable refunds and can then initiate and transmit a credit, e.g. via the Network 126, which is automatically credited (step 169(to the consumer's account, e.g. a consumer account in the consumer bank 124 (or, alternatively a consumer's credit card account or account with a company—as can be the consumer account credited in any embodiment of this invention).

With reference again to FIG. 4 and to step 162 in FIG. 5, the consumer computing unit 114 transmits the remittance information 130 directly back to the biller 112 via network 116 (as represented by arrow 134 in FIG. 4). The consumer computing unit 114 uses the biller's network address in address data field 204 of the data structure 190 to electronically route the payment remittance information 130 to the biller. Routing can be achieved in a variety of ways, including email, Internet URL addresses, and so forth. The payment remittance information is created by the biller in a particular format, and the payment remittance information 130 remains in the biller prescribed format for seamless integration to the biller's existing accounting system. Moreover, the payment remittance information is automatically returned to the biller without intervention by the consumer, except that the amount to be paid and the payment date are appended.

At step 166 in FIG. 5, the accounts for the consumer and biller are settled using the settlement subsystem of the bill presentment and payment system 110. In the FIG. 4 implementation, the biller 112 forwards the payment instructions onto the biller bank 122 (as represented by arrow 136 in FIG. 4). The biller bank 122 requests settlement with the consumer bank 124 via the clearing network 126. As an example, the biller bank 122 submits an ACH debit transaction which debits the consumer's account in consumer bank 124 for the amount of the payment authorized by the consumer (as represented by arrow 138 through clearing network 126).

FIG. 6 shows another implementation of a bill presentment and payment system in accordance with the invention, which is referenced generally by number 250. System 250 differs from the system 110 described with respect to FIG. 4 in that an intermediary 252 is interposed between the biller 112 and consumer 114. The intermediary 252 is a bill presentment and payment remittance service provider that handles billing responsibilities for the biller and payment instructions remitted back from the consumers. The intermediary 252 acts as a centralized bill warehouse and delivery mechanism that offers one gathering place for both billers and consumers. The intermediary 252 is equipped with a computing unit that is programmed to electronically handle the bills, remittance information, payment instructions, and staging and delivery instructions on behalf of many different billers and many different consumers. The intermediary functions can also be split among multiple entities. For example, one company can stage the bills and another company can handle the remittance processing. Other arrangements for handling the intermediary functions are also possible.

The biller 112 sends bill 128 and remittance information 130 to the intermediary 252 for staging. The intermediary 252 transfers the bill and remittance information to the appropriate consumers 114 at the prescribed billing times. Alternatively, the consumer 114 can periodically access the intermediary 252 for bills in his/her name or account number. The electronic transmission is carried out over the network 116.

The consumer reviews the bill, and if acceptable, authorizes payment. In the same manner as described above, the consumer enters the payment amount and date using the payment UI, and submits the remittance information 130 and payment instructions 140 back to the intermediary 252 over the network 116. Remittance information bound for a specific biller is pooled by the intermediary 252 and sent to that biller in batch. The intermediary 252 also produces payment instructions 254 that are in a file compatible with the clearing network 126. For instance, the PI254 might be in the form of an ACH-ready file used to settle accounts in ACH networks.

The biller 112 passes th payment instructions onto a concentrator 120 or biller bank 122. The biller bank 122 submits a debit transaction using the clearing payment instructions generated by the intermediary 252 to debit the consumer's account in consumer bank 124 for the amount of the payment authorized by the consumer. The intermediary's computing unit is programmed (as is, e.g. the biller computing unit 112, FIG. 4) to monitor prices of the goods or services purchased by the computer to calculate price differences; to validate applicable refunds; and to initiate and transmit a credit in an account of the consumer. Alternatively, any other computing unit in the system does this.

FIG. 7 shows another implementation of a bill presentment and payment system in accordance with the invention, which is referenced generally by number 260. System 260 is essentially the same as system 250 described above with respect to FIG. 6, with the primary difference being that the intermediary 252 sends the payment instructions (PI) 254 directly to the biller bank 122 as opposed to the biller 112. This eliminates having the biller handle the payment instruction file. In a variation of this implementation, the intermediary can be configured to submit the payment instructions directly, or through its own bank (not shown), to the clearing network 126.

In any system disclosed herein according to the present invention, an entity (e.g., but not limited to, a financial institution, a network, an ISP, a retail business, or an on-line entity) may have a consumer register or sign-up to receive the benefit of a best price guarantee. Such registration or sign-up may be for a predetermined, preselected period of time, e.g., a week, a month, or a year or it may be without time limit following an initial registration or sign-up. Registration or sign-up may be by phone, by mail, in person, and/or on-line. Registration or sign-up may be free; there may be a one-time charge or fee; there may be periodic charges or fees; there may be a charge or fee each time a transaction is entered into or until a pre-set number of transactions are completed; and/or there may be a charge or fee based on a percentage of the monetary sales amount for a transaction, with or without a cap or upper limit beyond which there are no more charges or fees.

The present invention, therefore, provides in certain, but not necessarily all embodiments, a method for electronically presenting and remitting payment of bills, and for guaranteeing a best price to a consumer for the subject matter of a transaction, including: generating a bill and associated payment remittance information at a biller; electronically transmitting the bill and associated payment remittance information to the consumer; enabling the consumer to authorize electronic payment of the bill; associating the electronic payment with the payment remittance information; transmitting the payment remittance information, including the structured remittance data, from the consumer back to the biller in the format prescribed by the biller; and guaranteeing a best price to the consumer for the goods or services that are the subject of the transaction; such a method wherein the payment remittance information is arranged within a data structure according to a format prescribed by the biller, the data structure having one or more open data fields to hold data that a consumer can enter or alter and one or more closed data fields to bold data that the consumer cannot alter, the remittance information further including hidden structured remittance data that is kept hidden from the consumer; and/or such a method including automatically providing a refund to an account of the consumer to effect a best price guarantee, said refund requiring no post-transaction action by the consumer.

The present invention, therefore, provides in certain, but not necessarily all embodiments, a method for electronically presenting and remitting payment of bills, and for guaranteeing a best price to a consumer for the subject matter of a transaction, including: generating a bill and associated payment remittance information at a biller, the payment remittance information being arranged within a data structure according to a format prescribed by the biller, the data structure having one or more open data fields to hold data that a consumer can supply or alter and one or more closed data fields to hold data that the consumer cannot alter, the remittance information further including structured remittance data that is kept hidden from the consumer; electronically transmitting a bill and associated payment remittance information from the biller to at least one intermediary; electronically transmitting the bill and payment remittance information from the intermediary to the consumer; presenting the bill to the consumer without revealing the structured remittance data; enabling the consumer to specify payment instructions which include at least one of a payment amount and a payment date; electronically transmitting the payment instructions and payment remittance information from the consumer to the intermediary; electronically transmitting the payment remittance information including the structured remittance data, from the intermediary back to the biller in the format prescribed by the biller; settling accounts between the consumer and biller using the payment instructions; and guaranteeing a best price to the consumer for the goods or services that are the subject of the transaction; and such a method including automatically providing a refund to an account of the consumer to effect a best price guarantee, said refund requiring no post-transaction action by the consumer.

The present invention, therefore, provides in certain, but not necessarily all embodiments, a computer-readable medium having computer-executable instructions for performing steps including: storing a bill and associated payment remittance information, the payment remittance information being arranged within a data structure according to a format prescribed by the biller, the data structure having one or more open data fields to hold data that a consumer can supply or alter and one or more closed data fields that hold data that the consumer cannot alter, the remittance information further including structured remittance data that is kept hidden from the consumer; presenting the bill to the consumer without revealing the structured remittance data; enabling the consumer to specify payment instructions including at least one of an amount to be paid on the bill, a payment date, and an account from which to draw payment, while prohibiting the consumer from altering data contained in the closed data fields; associating the payment instructions with the structured remittance data; electronically transmitting the payment instructions to initiate payment of the bill; electronically routing the payment remittance information, including the structured remittance data, in the biller prescribed format to the biller so that the structured remittance data is automatically returned to the biller without intervention by the consumer; and guaranteeing a best price to the consumer for the goods or services that are the subject of the transaction; such a computer-readable medium having further computer-executable instructions for performing a step of monitoring prices for the subject matter of the transaction; such a medium having further computer-executable instructions for performing a step of comparing prices for the subject matter of the transaction and calculating a refund, if any, due to the consumer; and/or such a medium having further computer-executable instructions for automatically crediting an account of the consumer to effect a best price guarantee; and a computing unit configured to read and perform the computer-executable instructions on the computer-readable memory as any recited above.

The present invention, therefore, provides in certain, but not necessarily all embodiments, an electronic bill presentment and payment remittance system including a network, a biller computing unit with computer-readable medium, and a consumer computing unit with computer readable medium, the computer-readable media having computer-executable instructions for performing steps including operatively linking the biller computing unit and consumer computing unit to the network; generating a bill for a consumer sales transaction to related to goods or services and associated payment remittance information in a particular format at the biller computing unit, the remittance information including structured remittance data that is kept hidden from a consumer; transmitting the bill and payment remittance information over the data network from the biller computing unit to the consumer computing unit; receiving the bill and payment remittance information at the consumer computing unit and presenting the bill to the consumer without revealing the structured remittance data to the consumer; facilitating entry of payment instructions including at least one of a payment amount and a date at the consumer computing unit, and following said entry, automatically routing the payment remittance information, including the structured remittance data, in the particular format to the biller computing unit; and guaranteeing a best price for the goods or services; and computer-readable media having such computer-executable instructions and further having computer-executable instructions to calculate and transmit a refund credit to an account of the consumer computing unit, e.g. by phone, by wireless communication, by radio or over the network.

The present invention, therefore, provides in certain, but not necessarily all embodiments, a system for conducting electronic commerce between a user and an electronic commerce merchant in a computer network that includes a plurality of user workstations coupled to a network server containing a collection of replaceable and extensible object-oriented software components that interoperate to provide back-end services including means for initiating an implementation of an abstract, object-oriented Cashier component to process payment requests by employing a number of replaceable software components or tools, means for generating an implementation of an abstract, object-oriented CashierDesk component that provides the Cashier component access to instances of other classes used in processing a transaction, means for entering a transaction into the Cashier component for processing for payment and issuing of a receipt for the transaction using the CashierDesk components, and means for guaranteeing to the user a best price for the transaction; such a system with means for providing a refund to the user in order to effect a best price guarantee; and/or such a system with means for providing the refund automatically to an account of the user, which refund requires no action on the part of the user after the transaction.

The present invention, therefore, provides in certain, but not necessarily all embodiments, an article of manufacture with a computer readable program code embodied on a computer network for conducting electronic commerce between a user and an electronic commerce merchant in a system that includes a plurality of user workstations coupled to a network server containing a collection of replaceable and extensible subject-oriented interface software components that interoperate to provide back-end services, the computer readable program code means in said article of manufacture with computer programming code which generates an implementation of an abstract, object-oriented Cashier Component to process payment requests by employing a number of replaceable software components or tools in a framework, computer programming code generating an implementation of an abstract, object-oriented CashierDesk component that provides the Cashier component access to instances of other classes used in processing a transaction, computer programming code entering a transaction into the Cashier component for processing for payment and issuing a receipt for the transaction using the CashierDesk components; and computer programming code guaranteeing a best price to the user for the transaction; such an article of manufacture with computer programming code for providing a refund to the user in order to effect a best price guarantee; and/or such an article of manufacture with computer programming code for providing the refund automatically to an account of the user, which refund requires no action on the part of the user after the transaction.

The present invention, therefore, provides in certain, but not necessarily all embodiments, a billing and payment authorization method, including defining a database having predetermined tolerance parameters for a billable entity, receiving billing information from a billing entity, the billing information including an amount the billable entity is to pay for a transaction whose subject matter is goods or services, after receiving the billing information, determining if the billing information received from the billing entity satisfies the predetermined tolerance parameters, providing the billable entity with remote access to the database to review the billing information submitted by the billing entity, and authorize payment of the billing entity, and guaranteeing to the billable entity a best price for the subject matter of the transaction; such a method including providing a refund to the billable entity in order to effect a best price guarantee and/or such a method including providing the refund automatically to an account of the billable entity, which refund requires no action by the billable entity after the transaction.

Any method according to the present invention may include a step in which a consumer engaging in a transaction is entered in a contest or a lottery with a chance to win a prize, an item, a service, and/or an amount of money. In one aspect this entry is automatic upon the consumer opting to have the best price guarantee with respect to an item or service purchased. In another aspect both the best price guarantee and the contest or lottery entry are automatic with the purchase of the item (or service), with or without an additional charge for the best price guarantee.

In another aspect, the consumer opts for the contest or lottery entry (whether the best price guarantee is automatic upon a purchase or is activated upon the consumer opting for the best price guarantee). In certain particular aspects the entry is free and in another aspect the consumer pays a pre-established amount for each contest or lottery entry. In another aspect, a consumer is eligible for the contest or lottery (or can opt to have an entry) only upon purchase of more than one item (or service and/or service); e.g., but not limited to, two, three four, five, six, seven, eight, nine, ten or eleven (or more) purchases. In one aspect such multiple purchases must occur within a pre-set time period, e.g., but not limited to, within a day, a week, two weeks, three weeks, a month, a plurality (two or more) months, a year, or a plurality (two or more) of years; and/or such multiple purchases must occur in the same sales location (e.g., but not limited to, one particular store or mall), in the same geographic area (e.g., but not limited to, within one mall area, one town, one city, one county, one state, or one country), in the same type and/or same chain of store, shop, business, or sales entity; and/or are purchases for the same item or service (or services) and/or are purchases for item (or services) from one category (e.g., but not limited to, office supplies, office furniture, or kitchen supplies).

In one particular aspect, the consumer herself or himself does not personally receive the award amount (or other prize); but the consumer gets to designate a charitable organization, educational entity, needy person, governmental entity, or service organization that receives the amount (or other prize). In one particular aspect, a consumer winning a monetary amount is given options for receiving the amount, e.g., but not limited to, one lump sum amount or a payout over time or both. In another embodiment any of the above methods and/or steps according to the present invention is used without a best price guarantee.

A contest or lottery monetary amount, according to one embodiment of the present invention, is based on a percentage of the value of purchases made by one specific consumer or by a plurality of distinct consumers, and these purchases may be: purchases of a particular item (or service); purchases within a particular time period; purchases within a particular geographic area; purchases from a particular entity, type of entity, or chain of entities; and/or purchases at or above a particular monetary value. Alternatively, instead of basing a won monetary amount on a percentage of value of purchases, the amount is determined by including in it a specific monetary amount for each purchase (each purchase by any consumer receiving the best price guarantee; or alternatively, not receiving such a guarantee); e.g., but not limited to one cent for each purchase whether the purchase is for an item (or service) that costs one, two, a hundred, or a thousand dollars. In another aspect, a consumer receives multiple entries depending on the amount of money spent for an item, items, service, and/or services; e.g., but not limited to, a consumer receiving an entry for each dollar spent and, therefor, e.g., receiving 112 entries upon spending $112. Alternatively, the amount is a pre-established fixed amount to be awarded at a pre-determined time to a consumer; and, in certain aspects, this consumer is one who has purchased an item (and/or service) or a pre-set number of items (and/or services) with a best price guarantee according to the present invention, or who has purchased items (or services) with a best price guarantee according to the present invention whose cost reaches a pre-set level.

The contest or lottery can be, according to the present invention, automatic and require no action on the part of the consumers with the first knowledge of entry into the contest or lottery and/or of winning the contest or lottery being a notification with a monthly account statement, a phone call, a letter, a personal notification (e.g. at home, at a workplace, or at a sales entity), an email notification, and/or when the consumer identifies himself or herself, e.g., but not limited to, upon the consumer using a credit card, smart card, or other electronic identifier, with the notification being electronic, e.g. on a touch pad, monitor or screen, and/or in person electronically and/or by a person in person.

In one particular aspect a contest or lottery monetary amount (or other prize) is made available, according to the present invention, for award instantly upon a consumer completing a purchase and receiving a best price guarantee according to any method according to the present invention and is, in certain aspects, either paid in cash instantly to the consumer or is credited instantly to an account of the consumer. The monetary amount (or other prize) in such methods is either pre-established or is determined by any method disclosed herein. Such an amount can be awarded, in certain aspects of the present invention, upon completion of a pre-set number of transactions, each of which includes a best price guarantee according to the present invention or can be awarded when a pre-set level for an amount is reached.

In another aspect a consumer instantly wins a contest or lottery monetary amount (determined in any way according to the present invention) or other prize upon purchase of a particular previously-designated item and/or service with a best price guarantee according to any method according to the present invention. Any known method may be used to identify the item or service, e.g., but not limited to, a bar code and/or a secret mark or identifier on the item or associated with the service.

In another aspect of the present invention a consumer wins a contest or lottery amount (or other prize) in any way according to the present invention and with a best price guarantee according to any embodiment according to the present invention by purchasing a particularly numbered item (or service) e.g., but not limited to, the one hundredth or ten thousandth item (or service) sold. For example, and not by way of limitation, XYZ Co. determines a lottery amount of $10,000 for the ten thousandth person to buy one of its ABC Model 2000 televisions within the state of Texas with the purchase for 99¢ of a best price guarantee that covers any ABC Model 2000 television sold within the next month within the state of Texas (with the best price guarantee put into effect by any method according to the present invention).

In one particular aspect of methods according to the present invention which include a best price guarantee method according to the present invention, when a consumer receives a price differential amount due to the best price guarantee and the account of the consumer to be credited with an amount equal to the amount of the price differential is an account that requires a minimum monthly payment and the price-differential amount equals or exceeds the amount of the minimum monthly payment, the minimum monthly payment (or part thereof) is made automatically with the price-differential amount.

In any method disclosed above instead of winning a monetary amount, a winning consumer can win a particular pre-established item or service.

The step or structure for any embodiment of the contest discussed above is indicated in the embodiments of FIGS. 5, 8, 9, 10 and 11 by “CONTEST optional” and it is within the scope of this invention to provide any of the contest steps, apparatuses or alternatives with any method according to the present invention. The various steps and/or programs for any of the contest steps according to the present invention are provided by appropriate software programs in the computer(s) used to effect the methods according to the present invention.

The present invention, therefore, in at least certain embodiments, provides a computer implemented method for guaranteeing a consumer a best price on an item or service purchased from a vendor in a first transaction at a first time at a first price, the first price paid by the consumer at the first time, the method including storing in a first database data for the first price and information identifying the consumer, inputting at least one second price for the item or service, said second price comprising a price for the item or service at a time later than the first time, determining, during a predetermined time period following the first time, any price of the at least one second price lower than the first price for the item, comparing the first price to the at least one second price and calculating a money-value difference between the first price and any price of the at least one second price lower than the first price, refunding to the consumer a refund amount equal to the money-value difference, and posting the refund amount as a credit to an account of the consumer; and entering the consumer in a contest, the consumer qualifying for said entering and for winning a prize in said contest by completing the first transaction. Such a method may include one or some of the following, in any possible combination: wherein the prize is from the group of an item or items, a service or services, a monetary amount, and/or a payment to the account of the consumer; wherein the prize is awarded for the consumer to designate for another entity other than the consumer; wherein the prize is a monetary amount paid personally to the consumer or to an account of the consumer in lieu of payment due on said account of the consumer; wherein the consumer is automatically entered in the contest upon completion of the first transaction; and/or wherein the prize is a monetary amount automatically credited to an account of the consumer.

The present invention, therefore, in at least certain embodiments, provides a computer program product comprising a computer storage medium having a computer program therein for guaranteeing a consumer a best price of an item or service purchased at a first price from a vendor in a first transaction at a first time, the first price paid by the consumer at the first time, said computer program performing the steps of receiving and storing in a first database data for the first price with a unique identifier identifying the consumer, receiving and storing in a second database at least one second price for the item or service, said second price comprising a price for the item or service at a time later than the first time, determining, during a predetermined time period following the first time, any price of the at least one second price lower than the first price, comparing the first price to the at least one second price, calculating a money-value difference between the first price and the at least one second price lower than the first price, generating a refund amount equal to the money-value difference, and crediting an account of the consumer with the refund amount; and in one aspect, wherein the computer program performs the step of entering the consumer in a contest, th consumer qualifying for said entering and for winning a prize in said contest by completing the first transaction.

The present invention, therefore, in at least certain embodiments, provides apparatus for guaranteeing a best price to a consumer for an item or service purchased at a first price at a first time from a vendor in a first transaction, the first price paid by the consumer at the first time, the apparatus including storage device, a processor device connected to the storage device, the storage device storing a program for controlling the processor, the processor operative to compare the first price to at least one second price for the item or service, said at least one second price temporally subsequent to the first price, determine whether the at least one second price is lower than the first price, and, if so, calculate a money-value difference between the first price and the at least one second price which is lower than the first price, generate a refund amount equal to the money-value difference, and to credit an account of the consumer with the refund amount; and in one aspect wherein the processor is operative to enter the consumer in a contest upon completion of the first transaction.

In conclusion, therefore, it is seen that the present invention and the embodiments disclosed herein and those covered by the appended claims are well adapted to carry out the objectives and obtain the ends set forth. Certain changes can be made in the subject matter without departing from the spirit and the scope of this invention. It is realized that changes are possible within the scope of this invention and it is further intended that each element or step recited in any of the following claims is to be understood as referring to all equivalent elements or steps. The following claims are intended to cover the invention as broadly as legally possible in whatever form it may be utilized. The invention claimed herein is new and novel in accordance with 35 U.S.C. § 102 and satisfies the conditions for patentability in § 102. The invention claimed herein is not obvious in accordance with 35 U.S.C. § 103 and satisfies th conditions for patentability in § 103. This specification and the claims that follow are in accordance with all of the requirements of 35 U.S.C. § 112. The inventors may rely on the Doctrine of Equivalents to determine and assess the scope of their invention and of the claims that follow as they may pertain to apparatus not materially departing from, but outside of, the literal scope of the invention as set forth in the following claims.

What is claimed is:

1. A computer implemented method for guaranteeing a consumer a best price on an item or service purchased from a vendor in a first transaction at a first time at a first price, the first price paid by the consumer at the first time, the method comprising
storing in a first database data for the first price and information identifying the consumer,
inputting at least one second price for the item or service, said second price comprising a price for the item or service at a time later than the first time,
determining, during a predetermined time period following the first time, any price of the at least one second price lower than the first price for the item,
comparing the first price to the at least one second price and calculating a money-value difference between the first price and any price of the at least one second price lower than the first price,
refunding to the consumer a refund amount equal to the money-value difference, and
posting the refund amount as a credit to an account of the consumer.

2. The method of claim 1 wherein the computer implemented method further comprises
entering the consumer in a contest, the consumer qualifying for said entering and for winning a prize in said contest by completing the first transaction.

3. The method of claim 2 wherein the prize is from the group consisting of an item or items; a service or services; a monetary amount; and a payment to the account of the consumer.

4. The method of claim 2 wherein the prize is awarded for the consumer to designate for another entity other than the consumer.

5. The method of claim 2 wherein the prize is a monetary amount paid to an account of the consumer in lieu of payment due on said account of the consumer.

6. The method of claim 2 wherein the consumer is automatically entered in the contest upon completion of the first transaction.

7. The method of claim 2 wherein the prize is a monetary amount automatically credited to an account of the consumer.

8. The method of claim 1 wherein the item or service is purchased by the consumer on-line via a network system.

9. The method of claim 1 wherein the item is purchased via a host system with at least one computer for implementing the computer implemented method and the host system records the first price and information identifying the customer; the host system conducts the monitoring, noting, and calculating steps.

10. The method of claim 9 wherein the host system provides the refund by crediting the account of the consumer.

11. The method of claim 10 wherein the account is an account of the consumer with the host system.

12. The method of claim 1 wherein a refund adjustment is made for each subsequent sales price lower than the at least one second price for the predetermined time period.

13. The method of claim 1 further comprising
monitoring sales of the item or service during the predetermined time period for any incentive provided to consumers purchasing the item or service following the first transaction, and
providing the consumer involved in the first transaction with a refund based on a money value of said incentive.

14. A computer program product comprising a computer storage medium having a computer program therein for guaranteeing a consumer a best price of an item or service purchased at a first price from a vendor in a first transaction at a first time, the first price paid by the consumer at the first time, said computer program performing the steps of
receiving and storing in a first database data for the first price with a unique identifier identifying the consumer,
receiving and storing in a second database at least one second price for the item or service, said second price comprising a price for the item or service at a time later than the first time,
determining, during a predetermined time period following the first time, any price of the at least one second price lower than the first price,
comparing the first price to the at least one second price,
calculating a money-value difference between the first price and the at least one second price lower than the first price,
generating a refund amount equal to the money-value difference, and
crediting an account of the consumer with the refund amount.

15. The computer program product of claim 14 wherein the computer program performs the step of entering the consumer in a contest, the consumer qualifying for said entering and for winning a prize in said contest by completing the first transaction.

16. The computer program product of claim 14 wherein the computer program performs the steps of
said at least one second price lower than the first price comprising a plurality of said second prices, the computer program further comprising
determining the lowest price of the plurality of said second prices and generating a refund amount corresponding to a money-value difference between said lowest price and said first price,
generating a refund amount equal to said money-value difference and,
crediting an account of the consumer with the largest money-value difference.

17. An apparatus for guaranteeing a best price to a consumer for an item or service purchased at a first price at a first time from a vendor in a first transaction, the first price paid by the consumer at the first time, the apparatus comprising
a storage device,
a processor device connected to the storage device, the storage device storing a program for controlling the processor,
the processor operative to
compare the first price to at least one second price for the item or service, said at least one second price temporally subsequent to the first price,
determine whether the at least one second price is lower than the first price, and, if so,
calculate a money-value difference between the first price and the at least one second price which is lower than the first price,
generate a refund amount equal to the money-value difference, and to
credit an account of the consumer with the refund amount.

18. The apparatus of claim 17 wherein the processor is operative to enter the consumer in a contest upon completion of the first transaction.

19. The apparatus of claim 17 wherein the processor is operative to credit the consumer's account by transmitting data indicative of the refund amount and data identifying the consumer from a first computer to a second computer, the second computer maintaining the account of the consumer.

20. The apparatus of claim 17 wherein
said at least one second price lower than the first price comprises a plurality of said second prices, the processor operative to
determine the lowest price of the plurality of said second prices and a refund amount corresponding to a money-value difference between said lowest price and said first price, and
generate a refund amount equal to said money-value difference.
